(19) United States
(12) Patent Application Publication
(10) Pub. No.: US 2013/0253982 A1
(43) Pub. Date: Sep. 26, 2013

(54) SYSTEM, METHOD AND APPARATUS FOR LOCATING PRODUCTS

(71) Applicant: Michael J. Sciore, Cherry Hill, NJ (US)

(72) Inventor: Michael J. Sciore, Cherry Hill, NJ (US)

(21) Appl. No.: 13/848,577

(22) Filed: Mar. 21, 2013

Related U.S. Application Data
(60) Provisional application No. 61/613,689, filed on Mar. 21, 2012.

(51) Int. Cl. G06Q 30/06

(52) U.S. Cl. CPC G06Q 30/0639
USPC 705/7.29; 705/26.9; 705/14.4; 705/26.7

(57) ABSTRACT

A system and method for locating a product within a store are disclosed. The system and method include a database for indexing at least one location of substantially each product within the store. The database includes information related to substantially each product. The system and method include a local device suitable to receive information related to a product to be located within the store. The local device is coupled to the database and identifies at least one product to locate from a comparison of the received information to the information included in the database. The system and method include a location engine that provides the location within the store of the identified at least one product.

### CROSS REFERENCE TO RELATED APPLICATIONS

This application claims the benefit of U.S. provisional application No. 61/613,689 filed Mar. 21, 2012, which is incorporated by reference as if fully set forth.

### FIELD OF INVENTION

The present invention is directed to system, method and apparatus for locating products, and more specifically, to system, method and apparatus for locating available products within a store, and providing supply chain information about the products.

### BACKGROUND

Searching for products within a store is one area of our lives that has seen little improvement with the increases in technology found in other aspects of our lives. For example, in a local store, such as a grocery store or hardware store, shoppers still use the end of the aisle guides that include three to five generic terms of products on shelves in that aisle to locate products. The three to five generic terms attempt to represent the hundreds of products that are included in that aisle.

In addition, shoppers today are facing increasing time constraints. These time constraints lead many shoppers to have a decreased amount of patience when searching for items. Certainly, employees at the store may aid in finding a product, but often shoppers do not request their services. Lost sales result from this changing environment. When a shopper goes to the store for a single product, he or she may spend a finite amount of time searching the aisle guides before leaving the store without purchasing the product. This type of lost sale represents just a fraction of the amount of sales that may be lost because shoppers are unable to locate desired items. Shoppers may go to a store to pick up a list of items. They may face time constraints that are placed on the shopping trip, such as before dinner, or before another obligation, for example. They may spend considerable time looking for one item on the list, only to run out of time. This leaves all of the other items on the list as lost sales. Alternatively, the shopper may find nine items on the list out of ten and fail to locate the tenth item before time expires on the trip. This tenth item is a lost sale.

These lost sales do not even account for the shoppers who become increasingly frustrated with the shopping experience and fail to return to the store. Such frustrated shoppers may shop online, where the online searching suits their needs, or may stop shopping at certain retail stores. These frustrated shoppers may only shop at certain stores when ample time is available—a condition that is much less prevalent today.

Thus, there exists a need for a system and method that enables shoppers to locate products within a store in a timely and less frustrating manner than exists today.

### SUMMARY

A system for locating a product within a store is disclosed. The system includes a database for indexing at least one location of substantially each product within the store. The database includes information related to substantially each product. The system includes a local device suitable to receive information related to a product to be located within the store. The local device is coupled to the database and identifies at least one product to locate from a comparison of the received information to the information included in the database. The system includes a location engine that provides the location within the store of the identified at least one product.

A system for locating a product within a store is disclosed. The system includes a communication interface for receiving information associated with the product to be located, a database that includes information about a plurality of products including the location of the product within the store, a processor for processing the received information to determine at least one of the plurality of products in the database as being the product to be located, and a display device for displaying the determined location of the product. The processor queries the database to determine the location of the product to be located.

A method for locating a product in a store is disclosed. The method includes identifying at least one product to locate from a comparison of input information to the information included in a database and providing the location of the at least one product within the store.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates a diagrammatic view of the system of the present invention;

FIG. 2 illustrates a method for locating product in a store;

FIG. 3 illustrates a screen shot of a screen of the present invention;

FIG. 4 illustrates a mapping to locate a product in a store;

FIG. 5 illustrates a mapping to locate a product in a store;

FIG. 6 illustrates a mapping to locate a product in a store;

FIG. 7 illustrates a method of upselling and advertising;

FIG. 8 illustrates a method that may be utilized in ordering products;

FIG. 9 shows an example computing device that may be used to implement features of the present invention;

FIG. 10 shows a screen of the computing device of FIG. 9;

FIG. 11a illustrates a unit according to an embodiment of the present invention for use in locating products;

FIG. 11b illustrates a unit according to an embodiment of the present invention for use in locating products;

FIG. 11c illustrates a unit according to an embodiment of the present invention for use in locating products;

FIG. 12 illustrates a screen shot of a screen of system; and

FIG. 13 illustrates a mapping to locate a product in a store.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in locator and mapping, merchandising, and ordering systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

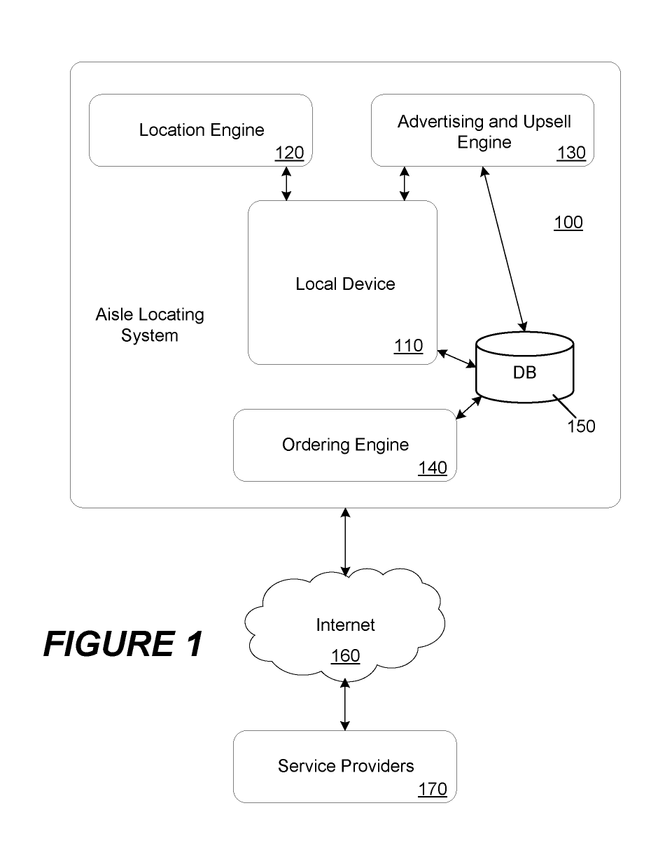

FIG. 1 illustrates a diagrammatic view of the system of the present invention. As shown in FIG. 1 there is a locating system 100. System 100 includes a local device 110, a location engine 120, an advertising and upsell engine 130, an ordering engine 140, and a database and/or storage medium 150. System 100 may be coupled to service providers 170 through the Internet 160.

System 100 includes database 150 for indexing at least one location of substantially each product within the store. Database 150 includes information related to substantially each product. This information may include product name, location, SKU or other barcode information, manufacturer, related products, available inventory and the like. Database 150 may also include reviews of products from and internal review organization, such as Home Depot reviews, for example, and reviews from national or international review bodies, such as Consumer Reports, for example.

System 100 includes local device 110 suitable to receive information related to a product to be located within the store. Local device 110 is coupled to database 150 and identifies at least one product to locate from a comparison of the received information to the information included in database 150. Local device 110 may include the unit with which a customer, consumer, or user interacts. Local device 110 may include a number of user interaction devices including a keyboard, speaker, microphone and visual display, for example. For example, local device 110 may include a user interface for inputting information about the product.

System 100 includes location engine 120 that provides the location within the store of the identified at least one product. Location engine 120 may include map(s) of the store as well as coordinated to identify the placement of the product within the store. Location engine 120 may also include access to aisle, section, and shelf to identify the location of products. Location engine 120 may include a store layout and stocking information for the store.

System 100 includes advertising and upsell engine 130 that provides the local device with products that represent increased margins. Advertising and upsell engine 130 may include or have access to information, such as may be contained within database 150, that enables placement of products in categories, and cost and price information related to each product so that engine 130 may make recommendations based on increased margins.

System 100 includes ordering engine 140 that identifies trends in product searches. System 100 includes a coupling of local device 110 to internet 160 and/or to at least one service provider 170. Ordering engine 140 may identify trends in product searches, such as an increase in grill searches during the spring season or snow shovels during the winter.

System 100 provides consumers with way to find the location of products within a store or nearby stores. System 100 provides products by category, problem solved, and products that are often purchased with other identified desired products. System 100 provides companies with the ability to meet consumers' expectations and to ensure that customers' needs are met.

Local device 110 may provide a user interface for inputting information about a product or products to be located within the store. Local device 110 may include a microphone to receive user speech, a keyboard to receive user typed input, a scanner to read product information, such as a barcode, for example. Drop-down menus and links may also be used to identify products from a hierarchical product menu system. Further, local device 110 may be used to identify products that perform certain tasks and may provide general searching within the store or for products. Users may also use local device 110 to read product reviews, find out about specials within the store, and see ratings of products within the store.

Local device 110 may display results from a search on the display window and/or may provide the ability to print a hard copy of the store map or directions to a located product within the store. Other information may also be output on a display screen and/or be available for printing.

Although local device 110 is shown as being distinct within system 100, and in particular distinct from location engine 120, advertising and up sell engine 130, ordering engine 140, and database 150, local device 110 may encompass any or multiple of these engines and storage media, and the depiction shown in FIG. 1 uniquely identifying these engines is for ease of understanding and illustration.

Local device 110 may include the ability to operate using a myriad of languages. Such language may include Spanish, English, French and German, by way of non-limiting example only. This language may include screen prompts, displays and user inputs. Such a language variation may enable system 100 to interact with potential customers who know/speak a language other than English.

Associated with the language display capabilities, database 150 may provide cross-references of products in multiple languages. Alternatively or additionally, a translation device may be used to convert information from English, the language used to store in database 150, to the language selected by a user for interaction. That is, system 100 may translate “on the fly” to the language selected and/or may contain information in database 150 in a plurality of languages selecting the appropriate information based at least in part on the language.

Location engine 120 may help shoppers locate products in the store, locate sale items, and identify products associated with the products or solutions to encountered problems. Location engine 120 may use a map that pinpoints the location of the requested product or products within the store. This may include providing aisle information and the location information of the search for product or products within a given aisle. Location engine 120 may include a store layout and may include stocking information for the store. Location engine 120 may also include information related to inventory information and locations at other stores such as, for example, a chain of stores.

Advertising and upsell engine 130 may include information from local device 110 and may be provided information from database 150 to provide local device 110 with advertising and/or product and upsell opportunities. Communication between local device 110 and advertising and upsell engine 130 may include identification of the product or products that a user requested to be located within the store. This information may allow advertising and upsell engine 130 to identify goods that the user is interested in and create an opportunity to provide the user with advertising for certain products and/or an opportunity to provide an item for sale with increased margins for the store. Advertising and upsell engine 130 may communicate with database 150 to retrieve advertising information from database 150 based on a decision made by engine 130. Further, engine 130 may query database 150 to provide other goods that may be linked to those item(s) requested to be located by user.

For example, if a user enters the store containing system 100 and interacts with system 100 by requesting the location of hammers, such as a Husky 20 oz. Steel Rip Hammer, engine 130 may provide information to local device 110 identifying an Estwing 20 oz. Straight-Claw Rip Hammer as a potential upsell from the Husky model requested. Engine 130 may provide an advertisement to local device 110 after interacting with database 150 to determine the Estwing Hammer is an upsell product for the Husky Hammer queried. Database 150 upon request from engine 130 may provide an advertisement for the Estwing Hammer and this advertisement may be relayed to local device 110 for display to the user requesting the Husky Hammer.

In addition, engine 130 may identify other products, such as nails, that may be used with a hammer. This identification may result from a relationship identified in database 150 and communicated to engine 130, and/or may be determined by engine 130. Information about other products may be provided to local device 110 for display to the user requesting the Husky Hammer.

Ordering engine 140 may identify products that are searched for by users that are not included in the available products of the store either because the store does not stock that item or because the store has sold all of those items. Further, ordering engine 140 may also identify products that are demonstrating trends such as customers increasing the number of searches, or decreasing the number of searches for the product. Ordering engine 140 may communicate this information to database 150. Database 150 may communicate information about the quantities of products within the store, other nearby competitor stores, or other stores within a chain of stores to be used in the logic of ordering engine 140.

Database and/or storage medium 150 may include any one or more organized collections of data for one or more purposes. The data may be in digital form or otherwise. The data may be organized to model relevant aspects of reality, such as products contained in aisles of a store, in a way that supports processes requiring this information, such as finding products in a store. Database may include the logical and physical materialization of its data, content, in files, computer memory, and computer data storage and the memory and storage itself. The memory and storage may include the physical devices used to store programs including the sequences of instructions of the present invention or data on a temporary or permanent basis for use in a computer or other digital electronic device.

Internet 160 may include any electronic or computer network, and may operate as a collection of computers and devices interconnected by communication channels that facilitate communications and allow sharing of resources and information among interconnected devices. That is, internet 160 may be a collection of two or more computers linked together for the purposes of sharing information, and resources, among other things. The interconnections may use circuit switching or message switching and devices may have a unique address so messages or connections may be routed to the correct recipients.

Service providers 170 may include any entity that communicates remotely with system 100. This may include advertisers, logistical support entities, and warehousing providers, by way of non-limiting example only. Logistical support entities may provide procurement, including carrier rate negotiations and selection, planning, including strategic network assessment and optimization of mode and carrier, execution, including day-to-day movement of freight, shipment tender, service monitoring, exception resolution and performance management, and administration, including invoicing, reporting, claims management, freight bill audit and payment, plus contract administration.

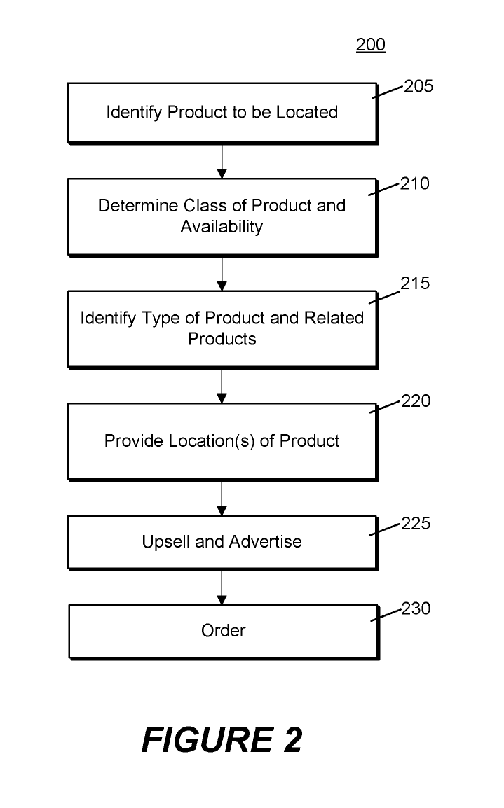

FIG. 2 illustrates a method 200 for locating a product in a store. Method 200 includes identifying the product to be located at step 205. Method 200 may include determining the class of product and availability of the product at step 210. Method 200 may further identify any related products at step 215. The locations of the identified product and any related products may be provided at step 220. Upselling and advertising of products may be included in method 200 at step 225. Method 200 may include ordering products at step 230 or printing out the location of the product.

Identifying the product to be located 205 may include an input by user where a user may input the name, type of product, or other identifying features of the product into the system. For example, if a user enters the store looking for razors, such a user may input “razors” into system 100. Alternatively or additionally, the user may input “MACH 5,” a specific type of razor, into system 100.

The uses or problems solved by a product may be input to identifying the product at step 205. For example, a user looking for a plunger may input “clogged toilet” into system 100. The products identified by such an input may include plungers and drain cleaners, for example. For example, system 100 may identify the product at step 205 by referencing database 150 and identifying a plunger as a product to fix a toilet clog. Database 150 may also identify other products to remedy the clogged toilet. Since the user did not specifically request a plunger, a myriad of products may be presented to the user for selection and further locating.

Selection windows and drop down menus may be used to identify the product at step 205. For example, a user may be able to select a category of products, such as plumbing or lumber, for example. If plumbing is selected, the user than may be provided with a selection of different plumbing products or categories of products. Upon selection of the subsequent category further products or categories of products may be displayed. The categories of products may take several layers. Ultimately, products may be displayed and/or described to the user for selection and further locating. By way of non-limiting example only, a user may select plumbing from a first menu, followed by selecting kitchen in a second menu. System 100 may then display to the user kitchen plumbing products for further user selection.

Determining the class of product and availability of the product at step 210 identifies the category of products that a product is in. This may be achieved by querying of database 150, for example, identifying a hammer as a tool and making a determination if a Husky 20 oz. Steel Rip Hammer is in stock. This identification may identify the Rip Hammer as a hammer and as a hand tool, for example. In such a situation, the class of product may be hammers and/or hand tools. Further, a determination may be made at step 210 as to the availability of the Rip Hammer.

Identifying any related products at step 215 may include providing other products that may be of interest, such as products based on the determined class of product. Related products may include blades for razors, nails for hammers, and other associated products, for example. Other less direct connections may be made through database 150. These less direct product connections may include wine to go with a movie, for example.

Providing the locations of the identified product and any related products at step 220 may include accessing location engine 120 and/or database 150 to locate the product within the store, and determining if the product is in stock at step 210. The aisle and location within the aisle may be provided. This may include dividing the aisle into quarters, or providing the number of feet down the aisle, for example. Additionally, the shelf and/or bin number of the product may be provided, such as on the third shelf, for example. Included with the location may be a picture of the item, either individually or as placed within the store, to aid in finding the product within the aisle. The location of any identified related products may also be provided. For example, if the searched item was a Husky 20 oz. Steel Rip Hammer, method 200 may output that the hammer is located in aisle 9 on the right side, third shelf, for example, and may additionally output that nails are located in aisle 10 on the left side. A map of the aisle including the location of relevant items may also be provided.

Upselling and advertising products at step 225 may be performed in advertising and upsell engine 130 in conjunction with database 150. Upselling as used herein refers collectively to both upselling and cross-selling. Upselling is a sales technique whereby a seller induces the customer to purchase more expensive items, upgrades, or other add-ons in an attempt to make a more profitable sale. Upselling usually involves marketing more profitable services or products, but may also be simply exposing the customer to other options that were perhaps not considered previously. Upselling implies selling something that is more profitable or otherwise preferable for the seller instead of, or in addition to, the original sale. Cross-selling is when a seller tries to sell something else based on known information. Collectively, upselling is used to enhance the value that the user or users get from the store or business in addition to maximizing the profit that the business gets from the user. For example, upselling may include suggesting a premium brand of a product when a brand is not specified by a customer, suggesting a brand of a product different from the brand specified by a customer, suggesting a customer purchase a more extensive product package, or buy a larger size product.

Advertising may also be included within method 200. Advertising is a form of communication used to persuade viewers to take some action with respect to products, ideas, or services. Most commonly, the desired result is to drive consumer behavior with respect to a commercial offering. Advertising messages may be paid for by sponsors and viewed on local device 110. This advertising may be based on the product or products that are to be located, or may be based on other factors, such as sales occurring in the store or locally with respect to the store, or based on paid airtime, all by way of non-limiting examples only.

Ordering products at step 230 may include placing orders for products to maintain inventory at certain level. Ordering products at step 230 may include inventory management. Inventory management, or inventory control, may include any attempt to balance inventory needs and requirements with the need to minimize costs resulting from obtaining and holding inventory. Inventory is a quantity or store of goods that is held for some purpose or use. Inventory may be kept “in-house,” meaning on the premises or nearby for immediate use; or it may be held in a distant warehouse or distribution center for future use. Stores often have hundreds or even thousands of products for sale. These products may have different part numbers and therefore require monitoring the inventory levels of each part number. This monitoring may occur, at least in part, using codes that are scanned when products are purchased.

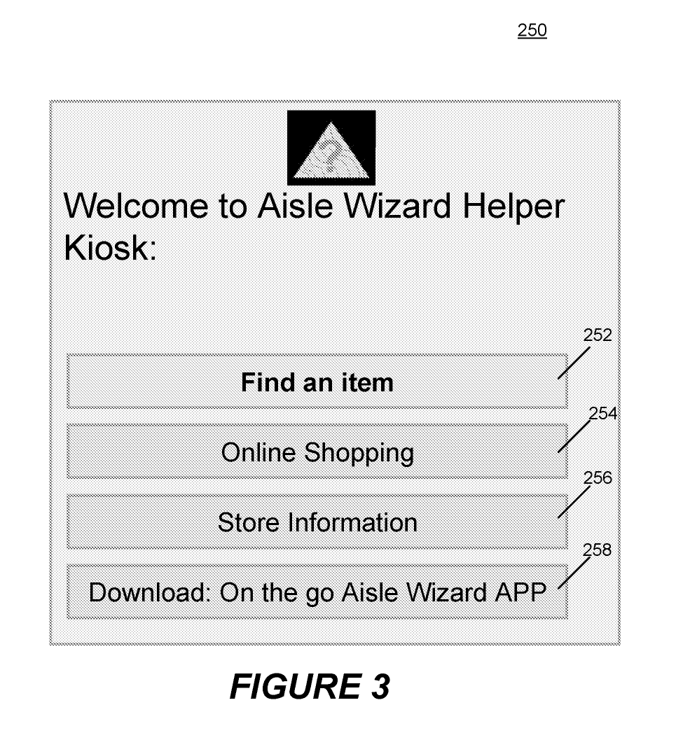

FIG. 3 illustrates a screen shot 250 of a screen of system 100. Screen shot 250 may include a welcome screen that enables a user to initiate locating a desired product. For example, in FIG. 3, screen shot 250 shows a welcome screen that enables a user to select an interactive button allowing the system to initiate “Find an item” 252, “Online Shopping” 254, “Store Information” 256 and a “Download: On the go Aisle Wizard APP” 258.

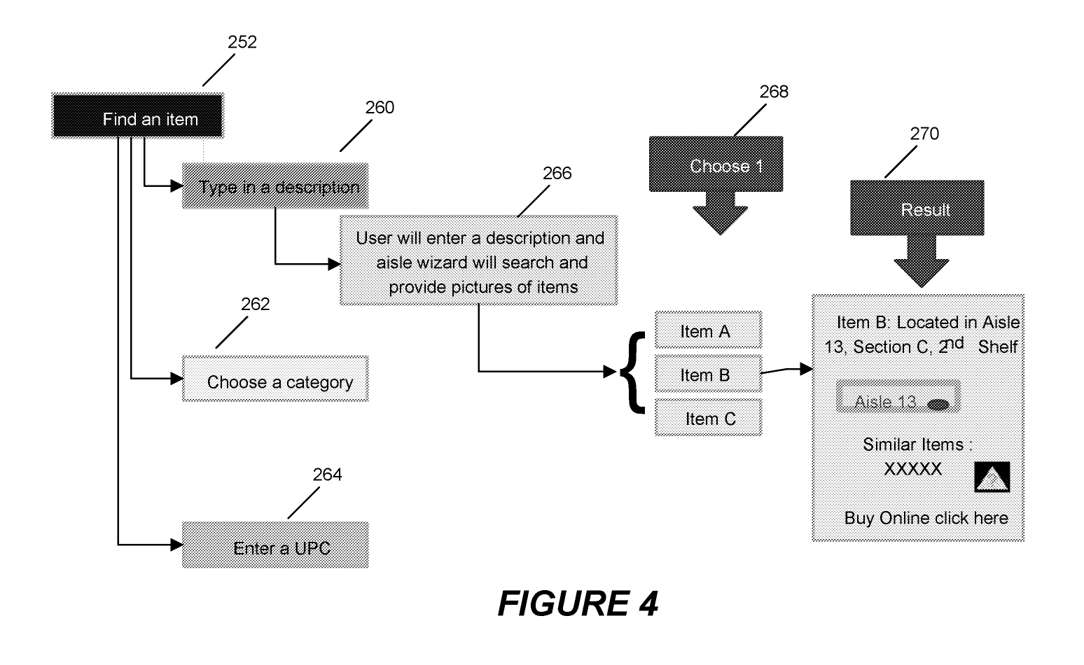

Initiate “Find an item” 252 may activate system 100 to interact with the user to locate the user's desired product. Referring now additionally to FIG. 4, FIG. 4 illustrates the mapping that occurs in locating the desired product. FIG. 4 illustrates three methods of locating an item: “Type in a description” 260, “Choose a category” 262, and “Enter a UPC” 264. One way to find an item is to “Type in a description” 260. Using such an entry technique, a user may enter a description into system 100 to search and provide information 266 regarding potential items that match the entered description. The information 266 provided may include pictures, descriptions, and universal product code (UPC) symbols of potentially matching items. While UPC symbols are used hereinthroughout, these UPC symbols, generally used within the United States, also include reference to an international article number or international article number (collectively EAN), often used within Europe and other parts of the world. By way of non-limiting example only, three items 268 may be identified and displayed to the user for selection. The displayed items 268 may include item A, item B, and item C, for example. The requesting user may review the items A, B, and C by reviewing the information 266. In this example, if the user selects item B, the result 270 of the located item B may be displayed to the requesting user. In this example, system 100 may identify item B as being located in Aisle 13, Section C, 2^{nd} Shelf. System 100 may also include with result 270 any similar or related items or products that may be of interest to the requesting user. An option to buy items online may also be provided.

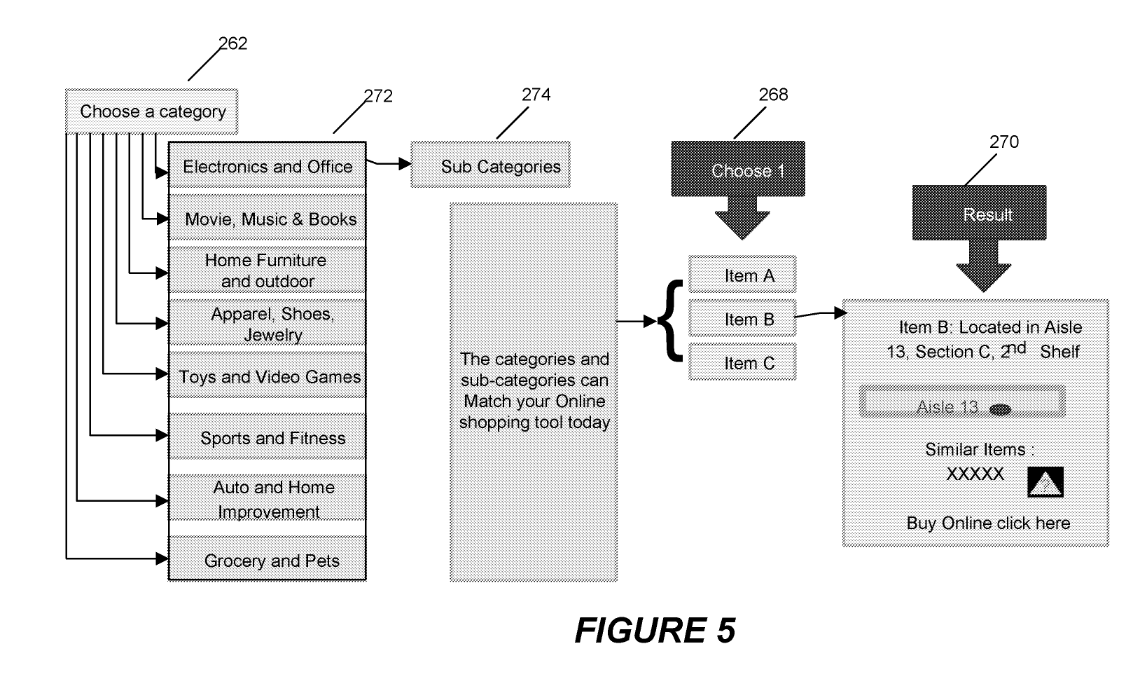

If the user selects “Choose a category” 262, the flow of FIG. 5 may be followed. FIG. 5 illustrates a “Choose a category” flow of locating an item in system 100. If a user selects “Choose a category” 262, a myriad of categories 272 may be provided for identifying an item to be located. By way of non-limiting example only, Electronics and Office, Movie, Music and Books, Home Furniture and Outdoor, Apparel, Shoes and Jewelry, Toys and Video Games, Sports and Fitness, Auto and Home Improvement, and Grocery and Pets categories may be provided. Categories 272 may be varied by store and the types of products that the store offers. The categories 272 of a grocery store may include categories 272 for each of the type of products located on the aisle marker signs, for example.

Once a category 272 is selected system 100 may cascade to sub-categories 274. While the present description and associated figures discuss one level of sub-categories 274, any number of levels of sub-categories are contemplated and focusing the discussion on a single sub-category level is for ease of understanding the present invention. Sub-categories 274 may be more specific categories associated with the selected category 272. For example, if category 272 is selected as spices, such as in a grocery store, for example, sub-categories 274 may include different types of spices and herbs, such as allspice, basil, caraway seed, cayenne, cumin, cloves, and the like. Upon selection of one of the sub-categories, a select number of items 268 may be displayed to the user. Using the example with respect to FIG. 4 and by way of non-limiting example only, three items 268 may be identified and displayed to the user for selection. The displayed items 268 may include item A, item B, and item C, for example. The requesting user may review the products A, B, and C by reviewing the information 266. In this example, if the user selects item B, the result 270 of the located item B may be displayed to the requesting user. In this example, system 100 may identify item B as being located in Aisle 13, Section C, 2^{nd} Shelf. System 100 may also include with result 270 any similar or related items or products that may be of interest to the requesting user. An option to buy items online may also be provided.

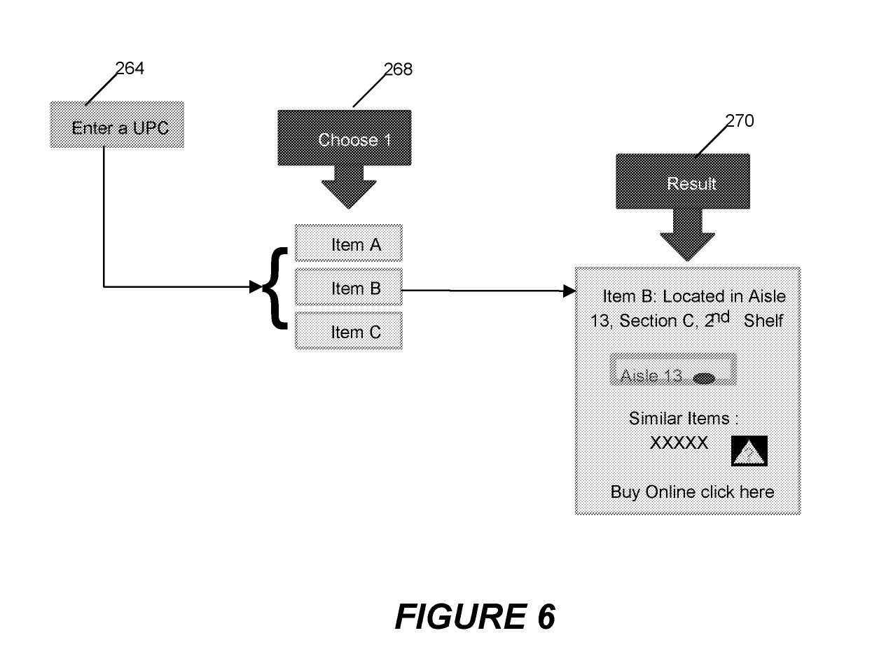

Referring now to FIG. 6, there is shown an “Enter a UPC” 264 flow of locating an item in system 100. A UPC may be entered by scanning, by typing in the code symbols or alphanumeric equivalent, or the like. From the entered UPC, and using the example with respect to FIG. 4, and by way of non-limiting example only, three items 268 may be identified and displayed to the user for selection. The displayed items 268 may include item A, item B, and item C, for example. The requesting user may review the products A, B, and C by reviewing the information 266. In this example, if the user selects item B, the result 270 of the located item B may be displayed to the requesting user. In this example, system 100 may identify item B as being located in Aisle 13, Section C, 2^{nd} Shelf. As with the discussion of FIGS. 4 and 5, system 100 may also include with result 270 any similar or related items or products that may be of interest to the requesting user. An option to buy items online may also be provided.

Referring now specifically to FIG. 3, initiate “Online Shopping” 254, and any of the options for buying items online discussed herein may include any process whereby users directly or indirectly buy goods or services from a seller in real-time, without an intermediary service, over the Internet, such as via electronic commerce, for example. The online shopping may provide an online shop, eshop, e-store, internet shop, webshop, webstore, online store, or virtual store that evokes the physical analogy of buying products or services at a bricks-and-mortar retailer or in a shopping centre, for example.

The initiate “Store Information” 256 may provide the user with certain information related to the stores and/or system 100. This information may include a general description and name of the store, the address and location information of the store, the telephone number, fax, and return policy of the store, and the like.

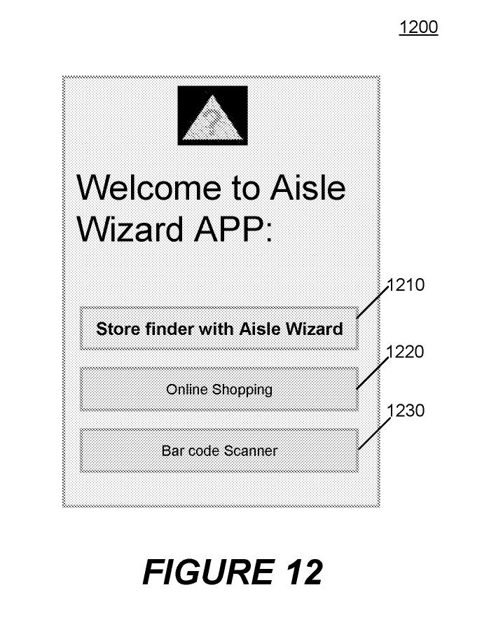

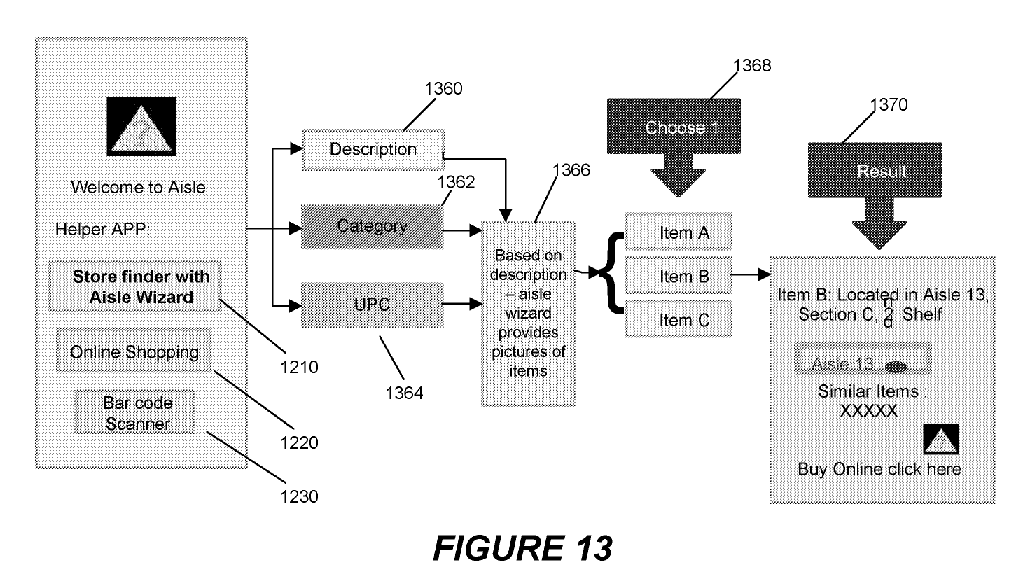

Initiating “Download: On the go Aisle Wizard APP” 258 may initiate the ability to download an application, such as for the user's phone or electronic device to aid in locating items within the store. A more detailed description of the application may be found hereinbelow with respect to FIGS. 12-13.

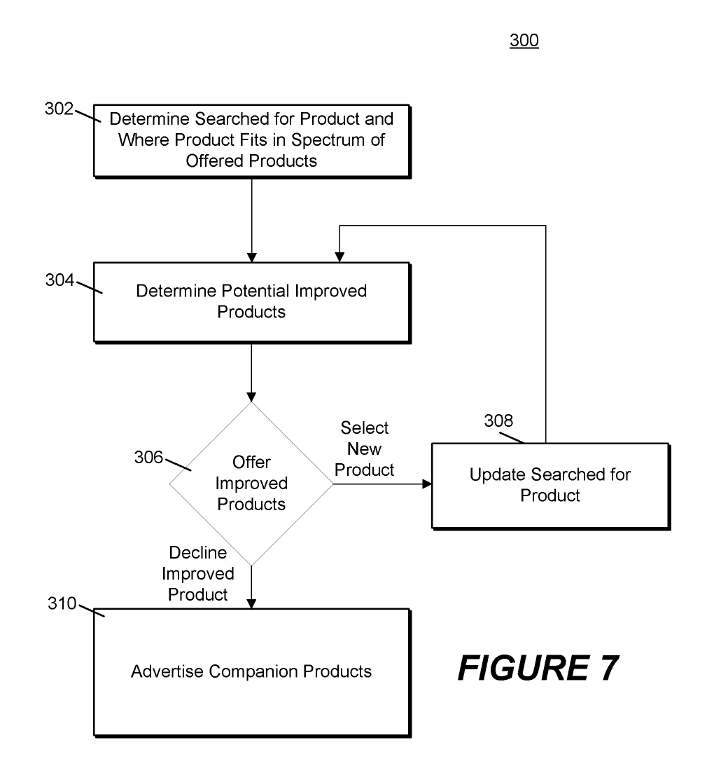

FIG. 7 illustrates a method 300 of upselling and advertising applicable within system 100. Method 300 includes determining where the search for product fits within a spectrum of offered products at step 302. Method 300 includes determining potential improved products at step 304. Method 300 includes offering improved products at step 306. If a user selects a new product, method 300 includes updating the searched for product at step 308 and looping back to determine potential improved products at step 304. If the improved products offered at step 306 are declined, method 300 may include advertising companion products at step 310.

Determining where the searched for product fits within a spectrum of offered products at step 302 may include accessing database 150 to determine other similar products. In the case of products, for example, there may be a standard model, a deluxe model, and a luxury model, for example. Often there may additionally be a store brand for a product, as well. Method 300 includes determining where the searched for product fits within this spectrum of offered products at step 302. A store may include in database 150 a compilation of the models of a product, including the store brand, standard, deluxe, and luxury product lines. A determination may be made 302 as to where the searched for product fits in this spectrum. There may be a scoring system provided, such as a 1 for store brand, 3 for standard, 6 for deluxe and 9 for luxury to aid in processing the information.

Once the determination is made as to where the searched for product fits within the spectrum of products, improved products at step 304 may be determined. This may occur by identifying the luxury and deluxe models of a searched for product via a reference to database 150, for example. The luxury and deluxe models may be improved products as compared to the standard model, for example.

These improved products may be offered 306 to a user. For example, the user may be queried that they requested a standard brand hammer and this blue handle hammer offers improved performance.

The offering of improved products at step 306 may be iteratively performed with the updated searched product at step 308 and looping to determine potential improved products at step 304 when a user selects an upgrade to the product as the updated searched product. This looping occurs by replacing the original searched for product with the newly selected improved product and repeating steps 304 and 306.

Advertising companion products at step 310 may also occur in method 300. Companion products may include products that are tied to the searched for product, such as blades to razors, for example, and may also include additional products that enable the searched for product to operate better. For example, if the searched for product is paint, a companion product may be brushes, buckets, and painters tape, for example. These companion products may be advertised to a user of system 100.

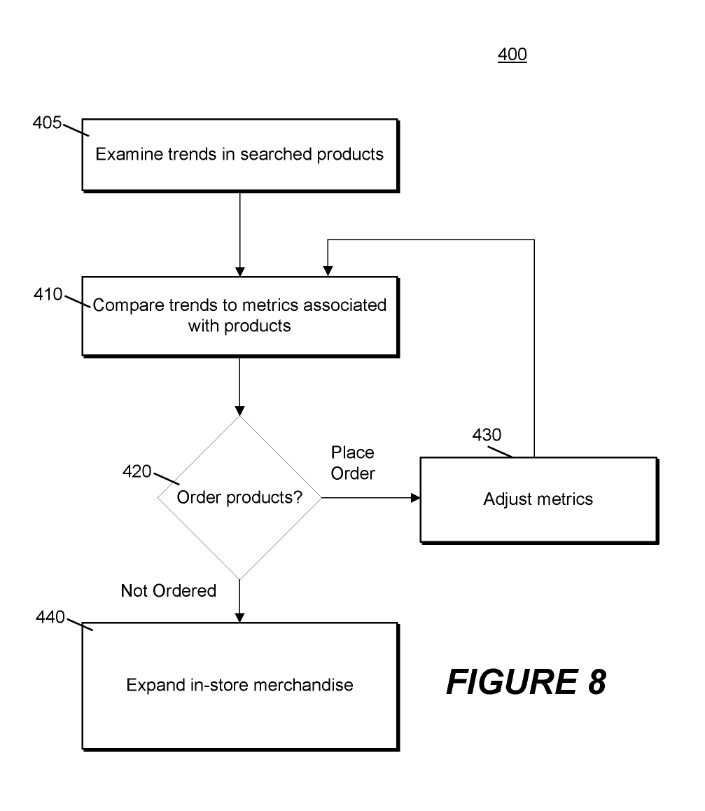

FIG. 8 illustrates a method 400 that may be utilized in ordering products. Method 400 includes examining trends in searched products at step 405 and comparing trends to metrics associated with products at step 410. Method 400 may include ordering products at step 420. If the order is placed, method 400 may include adjusting the metrics associated with the trends for the search products at step 430. If the product is not ordered, method 400 may include expanding in-store merchandise at step 440.

Examining trends in searched products at step 405 may include counting the number of times each product is searched. Further, this may include comparing the number of times a product is searched with the number of those products that are purchased. The trends may also include the correlation between purchases and searches and how this correlation is affected by the placement of the product within the store. That is, the correlation may track purchases and searches as a function of product placement within the store. The trends may be monitored over any period of time, such as one day, one week, one month, one year, and ten years, for example. In addition, multiple time periods of trends may be tracked and analyzed.

Comparing trends to metrics associated with products at step 410 may include comparing current trends to trends that are maintained within database 150. For example, comparing trends may include comparing current trends to historical trends over the same time period. For example, comparing trends may include daily comparisons of trends to same store trends during a same or similar timeframe. This may enable system 100 to account for increases in batteries when daylight savings time begins or ends commensurate with the recommended changing of batteries in smoke detectors, for example.

Ordering products at step 420 may include any element of inventory control and management. Ordering products at step 420 may include ordering product or products that have seen increased searching, for example. Ordering products at step 420 may include modifying inventory quantities for product or products based on results of the compared trends at step 410. More specifically, ordering products includes determining the quantity of products of each type to maintain in inventory and placing orders with vendors to maintain the inventory at the preset level.

Once an order is placed, an adjusting of the metrics associated with the trends for the search products at step 430 may occur. Such an adjusting may account for the additional ordered products, for example. The metrics may be adjusted to account for the additional products being held in inventory. For example, if the product at issue is drill bits and the metrics initially determine that there needs to be more inventory of drill bits, the adjusted metrics may account for the increased number of drill bits in inventory, allowing the compare trends at step 410 to be run again. A subsequent running of the comparison at step 410 may determine that with the increased drill bits in inventory, additional drills may need to be ordered. Such an order may be placed and then the metrics adjusted 430 again, followed by comparing the trends at step 410.

If the trends and metric comparison at step 410 determines that products need to be ordered, yet ordering products does not occur at step 420, a change in the in-store merchandise at step 440 may need to occur. For example, if the trends and metrics determine that additional drill bits need to be in inventory and the order for additional drill bits does not occur, expanding merchandise at step 440 may determine that the store is not interested in carrying drill bits and/or related products. In such a situation, a modification of the in-store merchandise may occur.

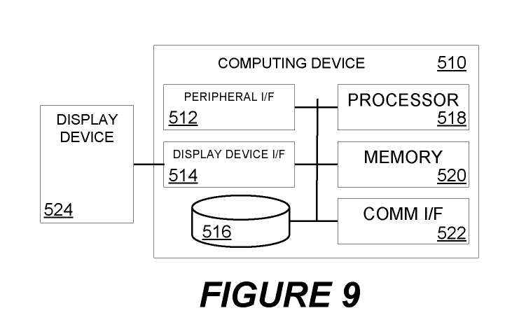

FIG. 9 shows an example computing device 510 that may be used to implement features describe above with reference to FIGS. 1-8. The computing device 510 includes a processor 518, memory device 520, communication interface 522, peripheral device interface 512, display device interface 514, and data storage device 516. FIG. 9 also shows a display device 524, which may be coupled to or included within the computing device 510.

The memory device 520 may be or include a device such as a Dynamic Random Access Memory (D-RAM), Static RAM (S-RAM), or other RAM or a flash memory. The data storage device 516 may be or include a hard disk, a magneto-optical medium, an optical medium such as a CD-ROM, a digital versatile disk (DVDs), or Blu-Ray disc (BD), or other type of device for electronic data storage.

The communication interface 522 may be, for example, a communications port, a wired transceiver, a wireless transceiver, and/or a network card. The communication interface 522 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 512 is configured to communicate with one or more peripheral devices. The peripheral device interface 512 operates using a technology such as Universal Serial Bus (USB), PS/2, Bluetooth, infrared, serial port, parallel port, and/or other appropriate technology. The peripheral device interface 512 may, for example, receive input data from an input device such as a keyboard, a mouse, a trackball, a touch screen, a touch pad, a stylus pad, and/or other device. Alternatively or additionally, the peripheral device interface 512 may communicate output data to a printer that is attached to the computing device 510 via the peripheral device interface 512.

The display device interface 514 may be an interface configured to communicate data to display device 524. The display device 524 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 514 may operate using technology such as Video Graphics Array (VGA), Super VGA (S-VGA), Digital Visual Interface (DVI), High-Definition Multimedia Interface (HDMI), or other appropriate technology. The display device interface 514 may communicate display data from the processor 518 to the display device 524 for display by the display device 524. As shown in FIG. 9, the display device 524 may be external to the computing device 510, and coupled to the computing device 510 via the display device interface 514. Alternatively, the display device 524 may be included in the computing device 500.

An instance of the computing device 510 of FIG. 9 may be configured to perform any feature or any combination of features described above as performed by the local device 110. Alternatively or additionally, the memory device 520 and/or the data storage device 516 may store instructions which, when executed by the processor 518, cause the processor 518 to perform any feature or any combination of features described above as performed by the locating system 100. Alternatively or additionally, each or any of the features described above as performed by the locating system 100 may be performed by the processor 518 in conjunction with the memory device 520, communication interface 522, peripheral device interface 512, display device interface 514, and/or storage device 516.

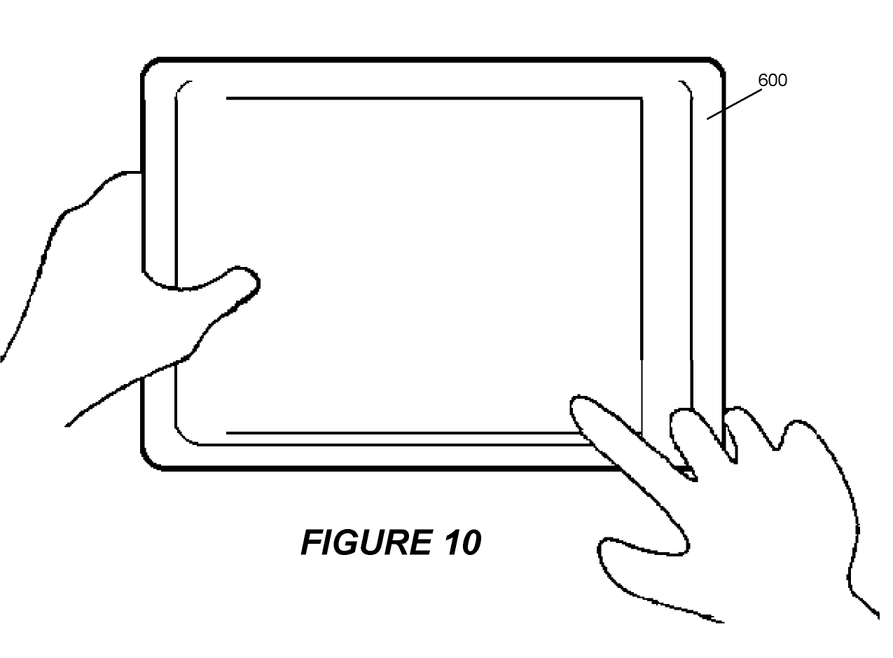

FIG. 10 shows a screen 600 of the computing device 510 of FIG. 9. The screen 600 may be controlled by a processor (not depicted), memory device (not depicted), communication interface (not depicted), peripheral device interface (not depicted), display device interface (not depicted), storage device (not depicted), and may be a touch screen display, which may possess characteristics of the processor 518, memory device 520, communication interface 522, peripheral device interface 512, display device interface 514, storage device 516, and display device 524, respectively, as described above with reference to FIG. 9. Screen 600 may receive user input using technology such as, for example, resistive sensing technology, capacitive sensing technology, optical sensing technology, or any other appropriate touch-sensing technology.

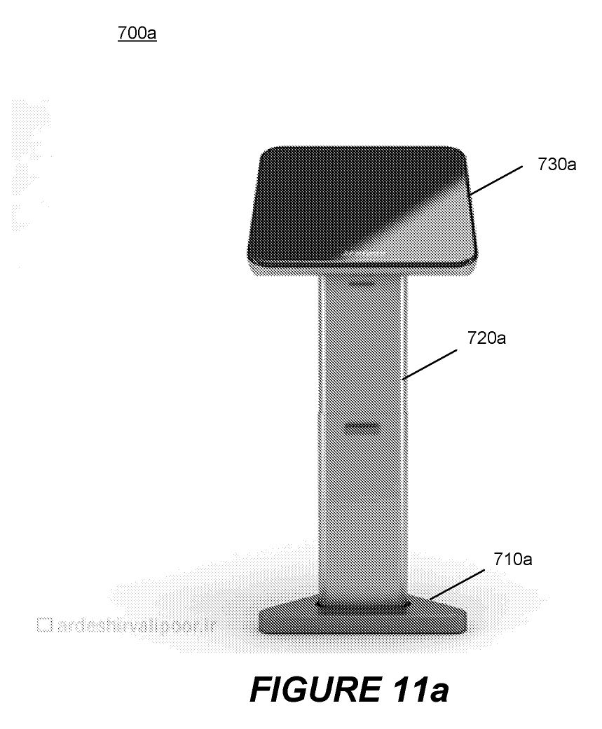

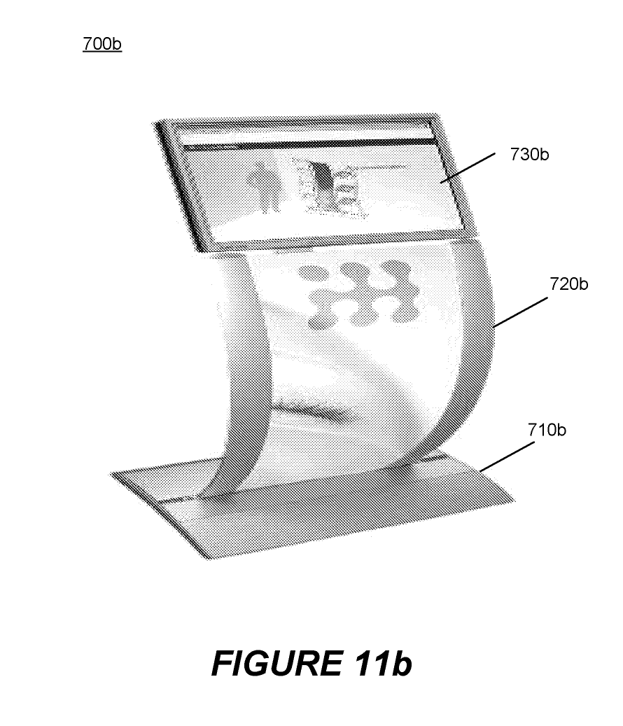

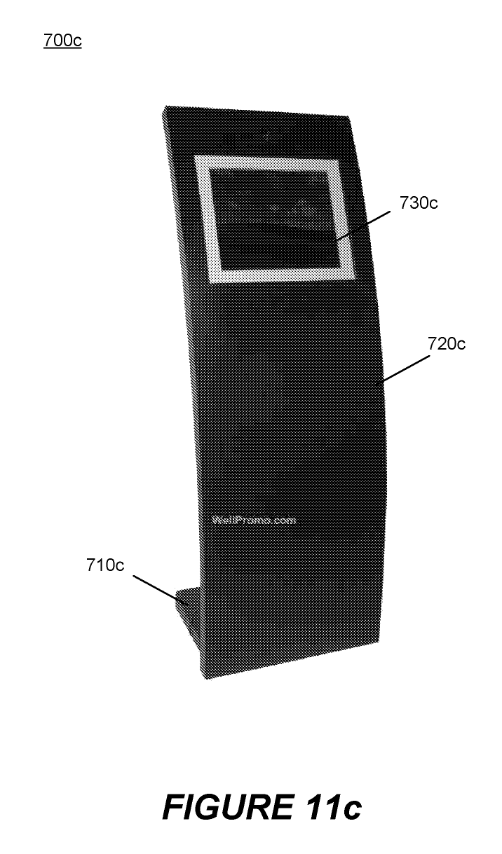

FIG. 11a illustrates a unit 700a according to an embodiment of the present invention for use in locating products that may be used to implement features describe above with reference to FIGS. 1-10. Unit 700a includes a base 710a providing support for the unit. A riser 720a is coupled to and supported by base 710a. Display 730a is coupled to and spaced from base 710a by riser 720a. Riser 720a may be configured to place the height of display 730a at an operable location. For example, if base 710a is located on the floor making unit 700a a floor display, riser 720a may be sized to provide display 730a to a user at an appropriate height, such as for example waist height or some other operate distance from the floor. Display 730a may take the form of screen 600, for example.

FIG. 11b illustrates a unit 700b according to an embodiment of the present invention for use in locating products that may be used to implement features describe above with reference to FIGS. 1-10. Unit 700b may be similar to unit 700a. Unit 700b similarly includes a base 710b providing support for the unit. A riser 720b is coupled to and supported by base 710b. Display 730b is coupled to and spaced from base 710b by riser 720b. Riser 720b may be configured to place the height of display 730b at an operable location. Display 730b may take the form of screen 600, for example.

FIG. 11c illustrates a unit 700c according to an embodiment of the present invention for use in locating products that may be used to implement features describe above with reference to FIGS. 1-10. Unit 700c may be similar to units 700a, 700b. Unit 700c similarly includes a base 710c providing support for the unit. A riser 720c is coupled to and supported by base 710c. Display 730c is coupled to and spaced from base 710c by riser 720c. Riser 720c may be configured to place the height of display 730c at an operable location. Display 730c may take the form of screen 600, for example.

FIG. 12 illustrates a screen shot 1200 of a screen of system 100. Screen shot 1200 may include a welcome screen that enables a user to initiate locating a desired product using an application. A user may download an application, such as onto a PDA, and may run this application to locate products within a store. Screen shot 1200 depicts a screen illustration of an application running on a user device. For example, in FIG. 12, screen shot 1200 shows a welcome screen that enables a user to select interactive button allowing the system to initiate “Store finder” 1210, “Online Shopping” 1220, and a “Bar code Scanner” 1230.

Referring now also to FIG. 13, Initiating “Store finder” 1210 enables three levels of finding an item, “Type in a description” 1360, “Choose a category” 1362, and “Enter a UPC” 1364 in a similar fashion to that described hereinabove. One way to find an item is to “Type in a description” 1360. Using such an entry technique, a user may enter a description for system 100 to search and provide information 1366 regarding potential items that match the entered description. The information 1366 provided may include pictures, descriptions, and UPC of potentially matching items. By way of non-limiting example only, three items 1368 may be identified and displayed to the user for selection. The displayed items 1368 may include item A, item B, and item C, for example. The requesting user may review the products A, B, and C by reviewing the information 1366. In this example, if the user selects item B, the result 270 of the located item B may be displayed to the requesting user. In this example, system 100 may identify item B as being located in Aisle 13, Section C, and 2nd Shelf. System 100 may also include with result 1370 any similar or related items or products that may be of interest to the requesting user. An option to buy items online may also be provided.

If the user selects “Choose a category” 1362, a myriad of categories (not shown) may be provided for identifying an item to be located. This is similar to that described with respect to FIG. 5. Again once a category is selected system 100 may cascade to sub-categories. While the present description and associated figures discuss one level of sub-categories 274, any numbers of levels of sub-categories are contemplated and focusing the discussion on a single sub-category level is for ease of understanding the present invention. Sub-categories may be more specific categories associated with the selected category.

If the user selects “Enter a UPC” 1364, a UPC may be entered by scanning, by typing in the code symbols or alphanumeric equivalent, or the like. This is similar to that described with respect to FIG. 6 hereinabove. From the entered UPC, items may be identified and displayed to the user for selection.

Initiating “Online Shopping” 1220, similar to the “Online Shopping” 254, includes any of the options for buying items online discussed herein. This includes any process whereby users directly or indirectly buy goods or services from a seller in real-time, without an intermediary service, over the Internet, such as via electronic commerce, for example. The online shopping may provide an online shop, eshop, e-store, internet shop, webshop, webstore, online store, or virtual store that evokes the physical analogy of buying products or services at a bricks-and-mortar retailer or in a shopping centre, for example.

Initiating “Bar code Scanner” 1230 may enable a user to scan in bar codes located on products, including, but not limited to entering a UPC described herein above. The scanning of the bar code may be performed with the application on the phone running the application. This may be achieved by initiating a camera on the phone to image the bar code at issue. The picture of the barcode may be decoded in the application to decode the specific information regarding the product associated with the bar code.

Although examples are provided above that relate to a locating system and related engines and apparati associated with the locating system to stores and products, the features described above with reference to FIGS. 1-13 are also applicable and/or may be used by, mutatis mutandis, any type of business, any type of non-business organization, and/or any individual. In particular, this locating system may be used in hospitals, malls, libraries, and other places that maintain a collection of things or people. Further, although many of the examples relate to products for sale, products for loan, rent, borrow may also be located. And although the examples relate to products, other items, goods, services and the like that may be tracked and located may utilize the present invention.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above with reference to the example architecture of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-13 may be used alone without the other features and elements or in various combinations with or without other features and elements. Sub-elements and/or sub-steps of the methods described above with reference to FIGS. 1-13 may be performed in any arbitrary order (including concurrently), in any combination or sub-combination.

As will be apparent to those skilled in the art, the engines within the locating system of the present invention may draw on any number of communication access points and media sources, including wired and wireless, radio and cable, telephone, television and internet, personal electronic devices, satellite, databases, data files, and the like, in order to increase content in the database and/or local device, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A system for locating a product within a store, the system comprising:
a database for indexing at least one location of substantially each product within the store, the database including information related to substantially each product;
a local device suitable to receive information related to a product to be located within the store, the local device coupled to the database and identifying at least one product to locate from a comparison of the received information to the information included in the database; and
a location engine that provides the location within the store of the identified at least one product.

2. The system of claim 1 wherein the information included in the database comprises a plurality of SKU numbers.

3. The system of claim 1 wherein the information included in the database comprises review of products included within the store.

4. The system of claim 1 wherein the received information comprises a product name.

5. The system of claim 1 wherein the received information comprises a task that the product performs.

6. The system of claim 1 wherein the database comprises an organized collection of data about substantially each product within the store.

7. The system of claim 1 wherein the local device comprises a user interface for inputting information about the product.

8. The system of claim 1 wherein the location engine comprises a map that identifies the at least one location of the product within the store.

9. The system of claim 1 wherein the location engine comprises at least one of an aisle, section, and shelf to identify the at least one location of the product within the store.

10. The system of claim 1 wherein the location engine comprises a store layout for the store.

11. The system of claim 1 wherein the location engine comprises stocking information for the store.

12. The system of claim 1 further comprising an advertising and upsell engine.

13. The system of claim 12 wherein the advertising and upsell engine provides the local device with products that represent increased margins.

14. The system of claim 1 further comprising an ordering engine.

15. The system of claim 14 wherein the ordering engine identifies trends in product searches.

16. The system of claim 1 further comprising linking the local device to the internet.

17. The system of claim 1 further comprising linking the local device to at least one service provider.

18. A system for locating a product within a store, the system comprising:
a communication interface for receiving information associated with the product to be located;
a database that includes information about a plurality of products including the location of the product within the store;
a processor for processing the received information to determine at least one of the plurality of products in the database as being the product to be located, the processor querying the database to determine the location of the product to be located;
a display device for displaying the determined location of the product.

19. The system of claim 18 wherein the information included in the database comprises a plurality of SKU numbers.

20. The system of claim 18 wherein the information included in the database comprises review of products included within the store.

21. The system of claim 18 wherein the received information comprises a product name.

22. The system of claim 18 wherein the received information comprises a task that the product performs.

23. The system of claim 18 wherein the database comprises an organized collection of data about substantially each product within the store.

24. The system of claim 18 wherein the display device comprises a map that identifies the determined location of the product.

25. The system of claim 18 wherein the displayed determine location of the product comprises at least one of an aisle, section, and shelf.

26. The system of claim 18 wherein the display device comprises a store layout for the store.

27. The system of claim 18 further comprising an engine that identifies trends in product searches.

28. A method for locating a product in a store, the method comprising:
identifying at least one product to locate from a comparison of input information to the information included in a database; and
providing the location of the at least one product within the store.

29. The method of claim 28 wherein a database indexes at least one location of substantially each product within the store.

30. The method of claim 28 wherein the input information is received via a local device within the store.

31. The method of claim 28 wherein the input information comprises a plurality of SKU numbers.

32. The method of claim 28 wherein the information included in the database comprises review of products included within the store.

33. The method of claim 28 wherein the received information comprises a product name.

34. The method of claim 28 wherein the received information comprises a task that the product performs.

35. The method of claim 28 wherein providing the location comprises a map that identifies the determined location of the product.

36. The method of claim 28 wherein providing the location comprises at least one of an aisle, section, and shelf.

37. The method of claim 28 further comprising determining the class of product to be located and availability of the to be located product.

38. The method of claim 37 further comprising determining potential improved products.

39. The method of claim 38 further comprising offering the determined improved products.

40. The method of claim 37 further comprising identifying companion products of the to be located product.

41. The method of claim 40 further comprising advertising the identified companion products.

42. The method of claim 28 further comprising identifying the type of product to be located and identifying any related products.

43. The method of claim 28 further comprising ordering additional products.

44. The method of claim 43 wherein the ordering is based on examining trends in searched for products.

45. The method of claim 43 wherein the ordering is based on comparing trends to metrics associated with products.
